(19) United States
(12) Patent Application Publication
(10) Pub. No.: US 2014/0316720 A1
(43) Pub. Date: Oct. 23, 2014

(54) DATA PROCESSING SYSTEM WITH REAL-TIME DATA CENTER AIR FLOW SIMULATOR

(71) Applicant: International Business Machines Corporation, Armonk, NY (US)

(72) Inventors: Colin G. Dumontier, Montpellier (FR); Gerard Laumay, Castelnau le Lez (FR); Nicolas Tallet, Montpellier (FR); Pascal Vezolle, Villeneuve les Maguelone (FR)

(73) Assignee: International Business Machines Corporation, Armonk, NY (US)

(21) Appl. No.: 14/182,685

(22) Filed: Feb. 18, 2014

(30) Foreign Application Priority Data
Apr. 17, 2013 (GB) 1306930.7

(51) Int. Cl. G01F 1/00; G06F 1/20

(52) U.S. Cl. CPC G01F 1/00; G06F 1/20
USPC 702/45

(57) ABSTRACT

Disclosed is a data processing system for use in a data center, the data center comprising a plurality of data processing systems. The data processing system comprises one or more sensors measuring air flow and temperature; computational flow dynamics software receiving input from said one or more sensors; and communication apparatus for communicating with others of said plurality of data processing systems. Also disclosed is a method of operating a data processing system for use in a data center, the data center comprising a plurality of data processing systems. The method comprises providing computational flow dynamics software to one or more of said data processing systems; providing communications apparatus to one or more of said data processing systems; the computational flow dynamics software receiving input from one or more sensors measuring air flow and temperature; and the communication apparatus communicating with others of said plurality of data processing systems.

### CROSS REFERENCE TO RELATED APPLICATION

This application claims the benefit of priority under 35 U.S.C. §119 from Application Number GB1306930.7, filed on Apr. 17, 2013 in the United Kingdom.

### FIELD OF THE INVENTION

The present invention relates to the management of cooling of data processing systems in a computer data center. More specifically, the present invention relates to the management of cooling using real-time Computational Fluid Dynamic (CFD) software associated with data processing systems in a computer data center.

### BACKGROUND

A computer data center typically comprises a number of data processing systems, located in a building that provides network connectivity, electrical power and cooling. Often the data processing systems are located in racks. The data processing systems may be a server. Racks may typically adhere to an IEEE standard and are measured in rack units or “U's” (each U is 19″ wide and 1.75″ tall). A rack server size is typically in multiples of these “U's”. There are many electronic devices other than servers which adhere to this IEEE standard, for example, networked storage devices and power backup devices.

Controlling and understanding air flows and temperature repartitions are essential to build and control optimal computer data centers in term of costs and PUE (Power Usage Efficiency). Computational fluid dynamic (CFD) simulations are used when building computer data centers as well as when defining the optimal positioning of the data processing systems such as racks and of cooling systems. CFD is a branch of fluid mechanics that uses numerical methods and algorithms to solve and analyze problems that involve fluid flows. Computers are used to perform the calculations required to simulate the interaction of liquids and gases with surfaces defined by boundary conditions. With high-speed supercomputers, better solutions can be achieved.

Conventional computer data center air flow simulations are static, the simulation being completed prior to the building of the computer data center installation using theoretical boundary simulation input data such as air flow velocities and temperatures. These simulations compute air flows, velocities and temperatures outside the data processing systems in the computer data center. The simulations require a conception phase to define and to model the computer data center and the data processing components as well as the spatial mesh (spatial discretization of the domain to simulate). Any modifications of the computer data center, such as data processing system displacement, new data processing systems and the like, requires a new simulation model with modified mesh, boundary conditions and the like. Moreover, the accuracy of the simulations depends strongly on the input data at the rack level such as boundary conditions for the simulation solver: air flow and temperatures fluxes, temperature and air velocity distribution. These boundary conditions are provided from sensor measures made during the conception phase or from theoretical values.

It would be desirable to provide an automatic, accurate and integrated solution allowing simulation in real-time of the air flow and temperature distribution in a data center. Solutions which are based on thermal camera visualization in real-time only give the temperatures but do not give any details about air fluxes. Additionally, such solutions do not provide a high level of accuracy, nor do they allow real time problem determination or alarms to be implemented.

### SUMMARY OF THE INVENTION

Embodiments of the present invention provide a data processing system for use in a data center, the data center comprising a plurality of data processing systems, the data processing system comprising: one or more sensors measuring air flow and temperature; a computational flow dynamics software receiving input from said one or more sensors; and a communication apparatus for communicating with others of said plurality of data processing systems.

Embodiments of the present invention also provide a method of operating a data processing system for use in a data center, the data center comprising a plurality of data processing systems, the method comprising: providing a computational flow dynamics software to one or more of said data processing systems; providing a communications apparatus to one or more of said data processing systems; the computational flow dynamics software receiving input from one or more sensors measuring air flow and temperature; and the communication apparatus communicating with others of said plurality of data processing systems.

Embodiments of the present invention also provide a computer program product for operating a data processing system for use in a data center, the computer program product comprising: a computer readable storage medium having computer readable program code embodied therewith, the computer readable program code adapted to perform the method described above when said program is run on a computer.

### BRIEF DESCRIPTION OF THE DRAWINGS

Preferred embodiments of the present invention will now be described, by way of example only, with reference to the following drawings, in which:

FIG. 1 shows a data center having a plurality of data processing systems in which embodiments of the present invention may be implemented;

FIG. 2 shows a block diagram of a data processing system of FIG. 1;

FIG. 3 shows a flow diagram of initialization of the data processing system of FIG. 2; and

FIGS. 4 and 5 show a flow diagram of operation of the data processing system of FIG. 2.

### DETAILED DESCRIPTION OF THE EMBODIMENTS

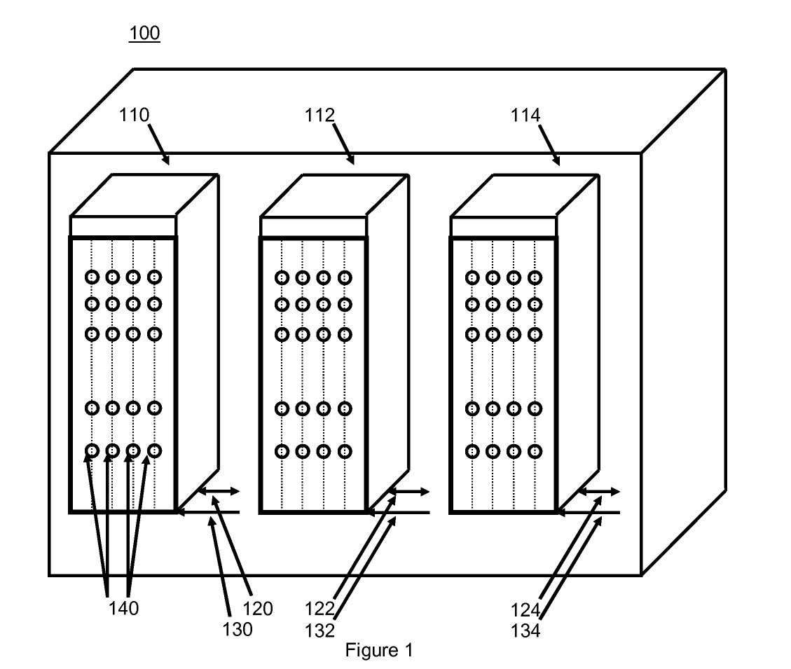

Referring to FIG. 1, a data center 100 is shown. The data center 100 is shown with three data processing systems 110, 112, 114. Any number of data processing systems 110, 112, 114 may be present in the data center 100 and the data center 100 may contain other pieces of equipment including, but not limited to, networked storage and power supply backup devices. Shown in FIG. 1 are network connections 120, 122, 124 and computation and power supply connections 130, 132, 134. Again, there may be other connections such as external communications connections. Each of the data processing systems 110, 112, 114 has one or more sensors 140 on the walls of the data processing equipment to measure air flow and/or temperature. The dashed vertical lines in FIG. 1 show a typical direction of air flow through the data processing systems 110, 112, 114.

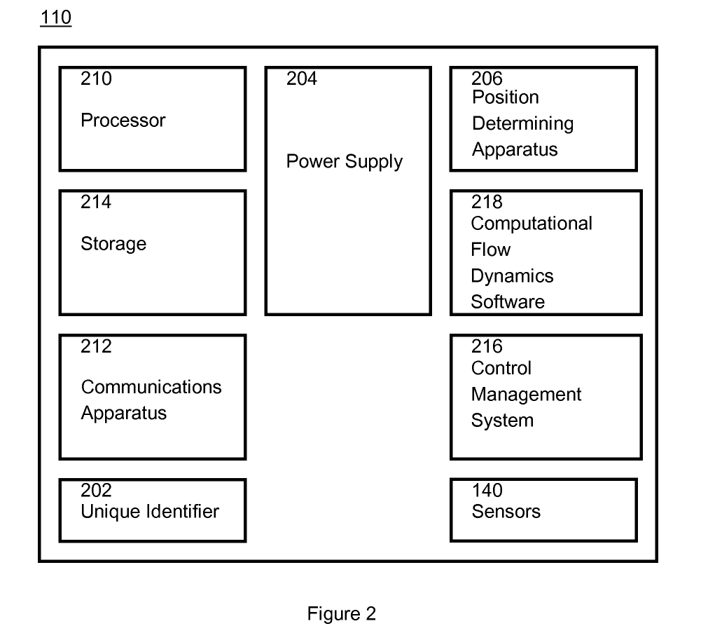

Referring to FIG. 2, a data processing system 110, 112, 114 is shown in which embodiments of the present invention may be practiced. Data processing system 110, 112, 114 has a unique identifier 202 used for the purposes of identifying that particular data processing system in the CFD calculations.

Data processing system 110, 112, 114 also has a power supply 204 for supplying power, typically low voltage, to the components within the data processing system 110, 112, 114. Power supply 204 receives power, typically high voltage, from the power supply connections (130, 132, 134 in FIG. 1) to the data processing system 110, 112, 114. In another embodiment, low voltage power is received by the data processing system 110, 112, 114 directly through power supply connections (130, 132, 134 in FIG. 1). Other embodiments for the transmission of power to, and receipt of power by, the data processing system 110, 112, 114 will be well known to the person skilled in the art.

Position Determining Apparatus 206 is optionally used to determine the precise position of the data processing system 110, 112, 114 within the data center 100. The Position Determining Apparatus 206 may use GPS technology or it may use a technology such as radio wave location technology, optionally using triangulation from a plurality of radio wave base stations. Other technologies may be used to determine the precise position of the data processing system 110, 112, 114 and will be well known to the person skilled in the art. In another embodiment, the data processing system 110, 112, 114 does not have Positioning Determination Apparatus 206 and the location information is manually entered.

Sensors 140 are located typically on the inner surfaces of the data processing systems 110, 112, 114. Sensors 140 measure air flow velocity and air temperature. The sensors 140 provide real time boundary conditions for use by the CFD software 218. This allows a much more accurate simulation of the air flows and temperatures within the data processing systems 110, 112, 114 and the data center 100. Other sensors may optionally be located within the data center 100 and may be connected to the data processing systems 110, 112, 114. Typically, the sensors 140 are connected to the Control Management System 216, but may optionally be connected to the processor 210 or any other part of the data processing system 110, 112, 114.

Processor 210 and storage 214 are provided within the data processing systems 110, 112, 114 to provide processing and storage for the conventional uses of the data processing systems 110, 112, 114. However, as each data processing system 110, 112, 114 has these features, the addition of additional data processing systems 110, 112, 114 means that the amount of processing power and data storage available to the CFD software 218 increases as each data processing system 110, 112, 114 is added. This allows embodiments of the present invention within data centers to be scalable, as additional complexity of the CFD solutions due to additional data processing systems 110, 112, 114 can be handled by the additional processing power and data storage available. The additional processing power and data storage may also be used to improve the accuracy of the simulation by using finer meshes and smaller time steps. The storage 214 preferably comprises volatile and non-volatile storage to gather and store in real time data from sensors in the data processing system 110, 112, 114 itself and also to store data about the internal components and systems within the data processing system 110, 112, 114 such as the inventory and location of components or systems, dimensions, weights, environmental data, electrical data, temperatures, event logs and the like.

Communications apparatus 212 is used to communicate with others of the data processing systems. It may also optionally be used to communicate with apparatus outside the data center. This may be achieved through network connections 120, 122, 124. The technology used may be any technology used for communication between data processing systems 110, 112, 114. This may include wired or wireless communication, it may include TCP/IP connections or it may be dedicated wired or wireless links.

Control Management System 216 requests information about the locations of data processing systems 110, 112, 114 if the data processing systems do not have the optional Position Determining Apparatus 206. It also requests information about the data center, such as the geometry, dimensions, and boundary conditions of the data center outside of the data processing system 110, 112, 114 levels. The information about the data center is typically provided by a user or by a configuration file. This data is typically requested just once by the first data processing system 110, 112, 114 which will typically transfer the data to other data processing systems. The Control Management Systems 216 within each of the data processing systems 110, 112, 114 communicate with each other through the Communications apparatus 212 in order to modify the data center configuration, including the generation of a new mesh based on the data processing system positioning, dimensions or boundary conditions.

Typically, there is one Control Management System 216 located in one of the data processing systems 110, 112, 114 which takes the role as master for the data center 100. Such a master may be used for a user and/or admin interface. Others of the Control Management Systems 216 may be provided for improved reliability and in case of failure of the master Control Management System 216. In other embodiments, there may be no master Control Management System 216, merely a number of peers. The Control Management System 216 may stop and restart simulations when the configuration data is changed, whether by the local Control Management System 216 or by a Control Management System 216 located within another data processing system 110, 112, 114.

CFD software 218 is used to simulate in real-time air fluxes and temperatures in the data center 100 and the data processing systems 110, 112, 114 without requiring any hardware or software external to the data processing systems 112, 114, 116.

The CFD software 218 typically uses three stages to complete a simulation. A pre-processing stage is followed by a simulation stage and then a post processing stage. In other embodiments, any or all of these stages may be combined or further subdivided. During the pre-processing stage, typically, the geometry (physical bounds) of the simulation problem is defined. The volume occupied by the fluid (air within the data center 100 and the data processing systems 110, 112, 114) is divided into discrete cells (the mesh). The mesh may be uniform or non uniform. The physical modeling is then defined, for example, the equations of motions, enthalpy, radiation and species conservation. The boundary conditions are then defined. This involves specifying the fluid behavior and properties at the boundaries of the problem. The simulation stage is then started and the equations are solved iteratively using discrete time steps until a solution is reached. Finally, the post processing stage is used for the analysis and, if desired, visualization of the resulting solution. In a preferred embodiment, the results of the simulation can determine whether it is necessary to generate alarms or actions.

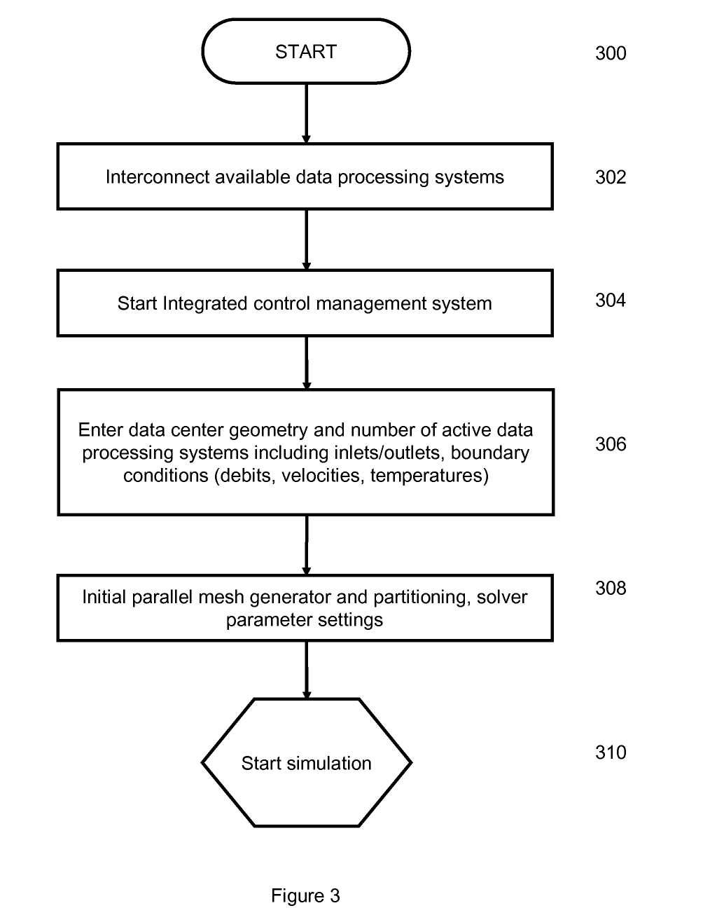

FIG. 3 shows a flow diagram of initialization of an embodiment of the present invention in the data processing system of FIG. 2. Processing starts at step 300. At step 302, data processing systems 110, 112, 114 in the data center 100 are interconnected. This may be achieved using the network interconnects 120, 122, 124 of each of the data processing systems 110, 112, 114. At step 304, the Control Management System 216 is started. At step 306, during a pre-processing stage, the data center 100 geometry and the number of active data processing systems 110, 112, 114 including the number and size of any inlets/outlets and the boundary conditions (debits, velocities, temperatures) are entered. At step 308, an initial parallel mesh generator and partitioning are set up and the solver parameter settings are determined. At step 310, the simulation stage is started.

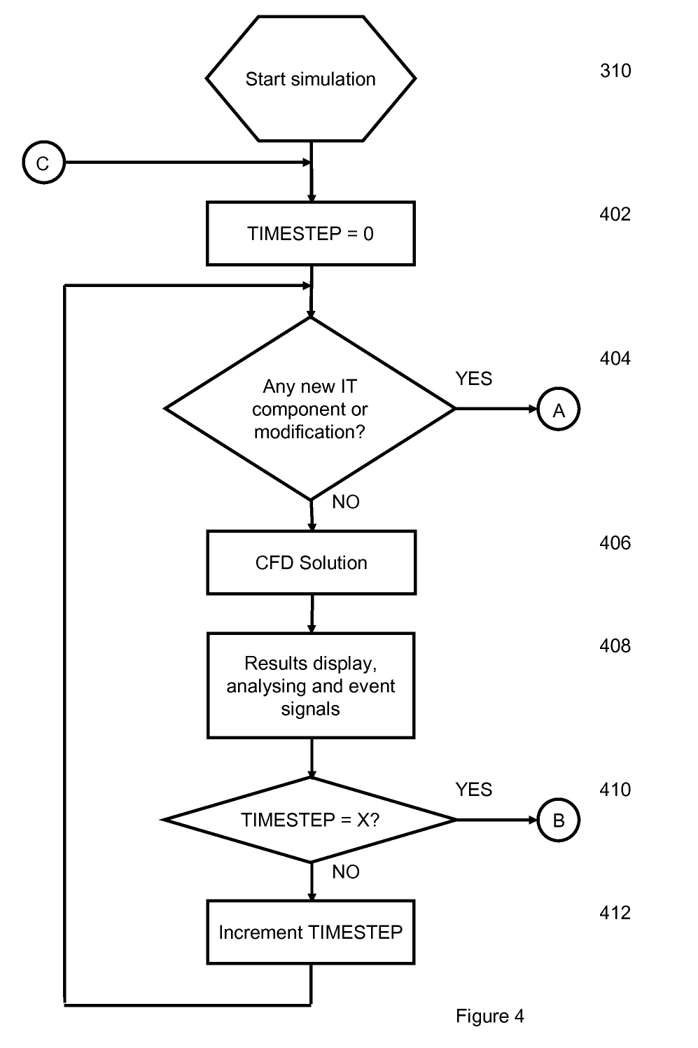

FIG. 4 shows a flow diagram of operation of the data processing system of FIG. 2. At step 310, the simulation stage is started. At step 402, TIMESTEP Variable is set to 0. TIMESTEP variable is used to determine how many iterations of the CFD simulation have been completed since the boundary conditions have been refreshed from real time sensor measurements. The TIMESTEP variable may also be used to respond to different events, such as that at step 404 described below, or may be changed at any time by a user or administrator of the system. Typically, this may be achieved by changing the predetermined value X described below. In an alternative embodiment, a different event may simply cause the boundary conditions to be updated, without requiring the value of the variable X to be changed. In a further alternative embodiment, the different events may cause the boundary conditions to be updated only at pre-determined steps in the process.

At step 404, a check is made as to whether any new IT component, such as an additional data processing system 110, 112, 114 having sensors and CFD software 218 for use in embodiments of the present invention have been added or whether any modifications have been made to any IT components which do not have the sensors and CFD software 218 for use in embodiments of the present invention have been added.

If no new IT component, with or without sensors and CFD software 218, has been added or any modifications made, then processing proceeds to step 406. The CFD software 218 executes. At step 408, the results from the CFD solution are displayed, analyzed and any event signals created. They may optionally be saved in local storage or in remote storage in order to improve the performance by reducing the time taken for each iteration. The event signals created may be one or more of sending air for cooling or for recirculation, an alarm condition or the display of suggested actions.

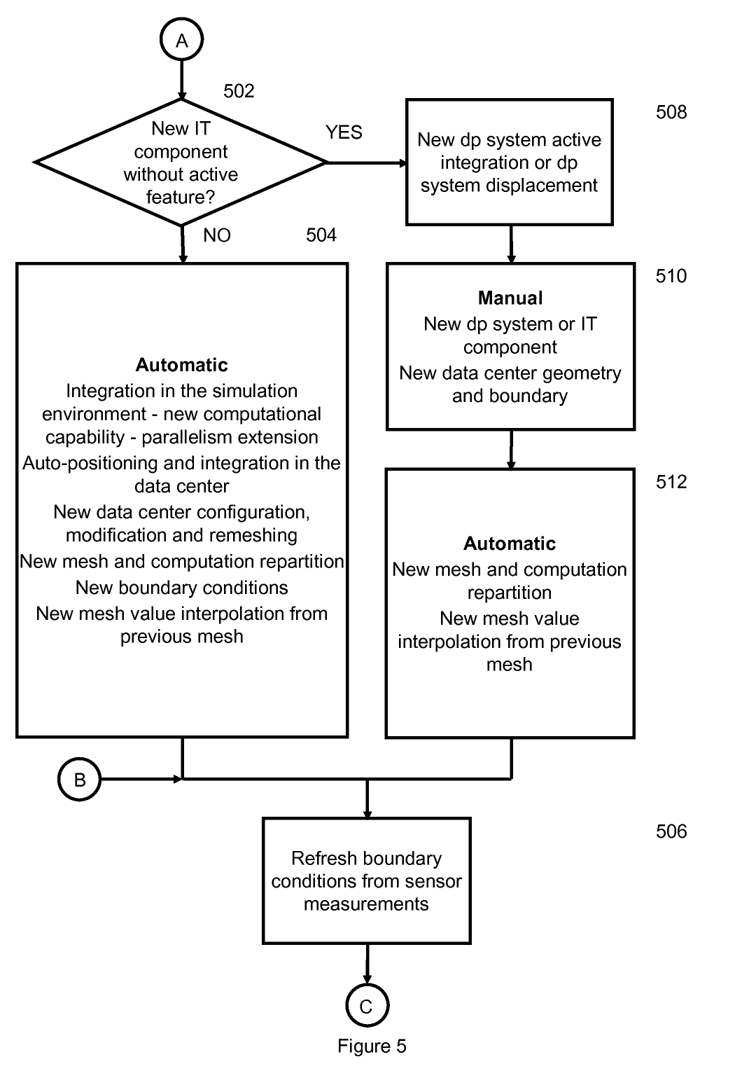

At step 410 a check is made as to whether the TIMESTEP variable is equal to a predetermined value X. If it is not equal to the predetermined value X, then, at step 412, the TIMESTEP variable is incremented and processing continues at step 404. If the TIMESTEP variable is equal to a predetermined value X, then processing proceeds to step 506 (FIG. 5). The TIMESTEP variable is used to determine how many iterations of the CFD simulation have been completed since the boundary conditions have been refreshed from real time sensor measurements in order to improve the performance of the CFD simulations. A number X of simulations are completed for each update of the boundary conditions, allowing better performance of the simulations than if the boundary conditions are updated for each of the simulations. If performance does not need to be optimized, then either the value of X may be made 0, or steps 402 and 412 may be omitted and step 410 may always be followed by step 506. As explained above with reference to step 402, the value of the variable X may be changed or boundary conditions may be caused to be updated, again as described above.

Referring to FIG. 5, processing proceeds from step 404 of FIG. 4 to step 502 of FIG. 5. At step 502, a check is made to determine if any modifications have been made to any IT components which do not have the sensors and CFD software 218 for use in embodiments of the present invention have been added, that is any IT components without an active feature. If such a modification has been made, processing proceeds to step 508. If no such modification has been made, that is the new IT component is an additional data processing system 110, 112, 114 having sensors and CFD software 218 for use in embodiments of the present invention have been added, processing proceeds to step 504.

At step 504, the newly connected data processing system 110, 112, 114 communicates with one or more of the Control Management Systems 216 in the existing data processing systems 110, 112, 114. The Control Management Systems 216 integrates the new data processing system 110, 112, 114 into the simulation environment by including, for example, the additional new computational capability of the newly added data processing system 110, 112, 114. This includes using the CFD software 218 in the newly added data processing system 110, 112, 114. The Control Management Systems 216 stops the simulation or waits until the present simulation has completed and then incorporates into the simulation, the location and dimensions of the newly added data processing system 110, 112, 114 as well as the computational capabilities associated with the newly added data processing system 110, 112, 114. The location may be determined by the Position Determining Apparatus 206 of the newly added data processing system 110, 112, 114. Also incorporated into the simulation are the new data center configurations. A new mesh is generated and the associated computation required is repartitioned to take into account the added computing capabilities of the newly added data processing system 110, 112, 114. New boundary conditions are incorporated into the simulation which reflect the extra boundary condition information which will be received from the newly added data processing system 110, 112, 114. Values for the new mesh are calculated by interpolation from the previous mesh.

Processing proceeds from step 502 to step 508 instead of step 504 above if any modifications have been made to any IT components which do not have the sensors and CFD software 218 for use in embodiments of the present invention have been added. At step 510, any modifications to the data center such as adding or deleting, switching out/up or changing the location of any IT component or any data center boundary conditions, such as a new data center geometry or boundary, that cannot be handled by a Control Management System 216 of the data processing system 110, 112, 114 must be entered manually. This will typically be the case if the data processing system 110, 112, 114 or other IT component does not have the active components described with reference to FIG. 2 above installed. These changes can impact the fluid and thermal behavior used by the CFD software. This data is typically entered manually by the use of a graphical user interface or a configuration file. In an embodiment, the configuration file may be used to make changes to a registry. Once these changes have been manually entered, processing proceeds to step 512.

At step 512, a new mesh is generated and the associated computation required is repartitioned between the existing data processing systems 110, 112, 114 to take into account the added or changed IT component. As the new or changed IT component does not have the active components described with reference to FIG. 2 above installed, the new or changed IT component cannot provide computing resources to help with the real time CFD simulation. Values for the new mesh are calculated by interpolation from the previous mesh.

Processing proceeds to step 506 from any one of (i) step 410 where the boundary conditions are updated only every X simulations; (ii) step 504 where a new IT component with the active feature has been added; or (iii) step 512 where a new IT component without the active feature has been added.

At step 506, the boundary conditions are refreshed from the sensor 140 measurements. Processing returns to step 402 in FIG. 4 and another simulation starts.

The advantages of embodiments of the present invention include:
Autonomous and automatic: No hardware or software external to the data processing systems 110, 112, 114 is required. Each data processing system 110, 112, 114 has the capability to simulate the air fluxes and temperatures in the data center 100. When a new data processing system 110, 112, 114 is installed in a data center 100 it is connected to the network through connections 120, 122, 124. The integrated Control Management System 216 requests information about the data processing system 110, 112, 114 location and the data center 100 data as described above.
Accuracy: Because of the sensors 140 integrated into each of the data processing systems 110, 112, 114, there are no assumptions required in the CFD software 218 regarding boundary conditions at a data processing system 110, 112, 114 level. The provision of accurate and real time air fluxes and temperature is a key point to ensure the accuracy of the simulation.
Real-time: At each time step the air fluxes and temperatures can be displayed and recorded. Any modification of the data center 100 is immediately detected by the Control Management System 216 or the integrated sensors 140, and the modifications are transferred to the simulation.
Scalable: Each new data processing system 110, 112, 114 adds computational capabilities (processor 210 and storage 214). Because of the parallel CFD software 218 the simulation is distributed across the data processing systems 110, 112, 114 which provide improved performance and accuracy through the use of finer meshes and smaller time steps.
Compatibility: Embodiments of the present invention can be used with any existing data centers without any modification of the existing cooling system being required. Under the second edition of the American Society of Heating, Refrigerating and Air-Conditioning Engineers (ASHRAE) specifications, the optimal temperature for data center operations increases from the 20 degrees C. (68 degrees F.) of the first edition to 27 degrees C. (80.6 degrees F.). A forthcoming third edition is expected to raise this optimal temperature even further. This means that the air entering servers can be hotter than it was previously; meaning that thermal management according to embodiments of the present invention becomes even more important than before.

Embodiments of the invention can take the form of a computer program accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-RW), and DVD.

1. A data processing system for use in a data center, the data center comprising a plurality of data processing systems, the data processing system comprising:
one or more sensors measuring air flow and temperature;
a computational flow dynamics software receiving input from said one or more sensors; and
a communication apparatus for communicating with others of said plurality of data processing systems.

2. The data processing system of claim 1, wherein:
said data processing system has one or more outer surfaces; and
said sensors are located on said one or more outer surfaces so as to provide information as to boundary conditions for said computational flow dynamics software.

3. The data processing system of claim 1, further comprising a position determination apparatus to determine a geographical location of said data processing system.

4. The data processing system of claim 1, wherein said communication apparatus sends and receives data from said one or more sensors between the computational flow dynamics software located in respective data processing systems.

5. The data processing system of claim 1 wherein said computational flow dynamics software generates a configuration mesh based on each of the data processing system positioning, dimensions and boundary conditions.

6. The data processing system of claim 1, wherein outputs from said computational flow dynamics system cause one or more of: sending air for cooling, sending air for recirculation, an alarm condition, and the display of suggested actions.

7. A method of operating a data processing system for use in a data center, the data center comprising a plurality of data processing systems, the method comprising:
providing a computational flow dynamics software to one or more of said data processing systems;
providing a communications apparatus to one or more of said data processing systems;
the computational flow dynamics software receiving input from one or more sensors measuring air flow and temperature; and
the communication apparatus communicating with others of said plurality of data processing systems.

8. The method of claim 7, wherein:
said data processing system has one or more outer surfaces; and
said one or more sensors located on said one or more outer surfaces so as to provide information as to boundary conditions for the computational flow dynamics software.

9. The method of claim 7, further comprising the step of:
providing a position determination apparatus to determine a geographical location of the data processing system.

10. The method of claim 7, wherein said communication apparatus sends and receives data from said one or more sensors between the computational flow dynamics software located in respective data processing systems.

11. The method of claim 7, wherein said computational flow dynamics software generates a configuration mesh based on each of the data processing system positioning, dimensions and boundary conditions.

12. The method of claim 7, further comprising the step of sending initialization data between the computational flow dynamics software in respective data processing systems.

13. The method of claim 12, wherein:
said initialization data is requested from an added or modified data processing system by one of said plurality of data processing systems; and
said initialization data is distributed to others of said plurality of data processing systems by said one of said plurality of data processing systems.

14. The method of claim 7, further comprising:
determining whether an additional data processing system is added for use in the data center;
responsive to determining an additional data processing system is added, communicating with the additional data processing system; and
integrating added computational capability of the additional data processing system with the computational flow dynamics software.

15. The method of claim 14, further comprising:
generating a configuration mesh incorporating each of the data processing system positioning, dimensions, and boundary conditions of the plurality of data processing systems and the additional data processing system.

16. A computer program product for operating a data processing system for use in a data center, the data center comprising a plurality of data processing systems, the computer program product comprising:
a computer readable storage medium having computer readable program code embodied thereon, the computer readable program code adapted to perform the following steps when said program product is run on a computer;
providing a computational flow dynamics software to one or more of said data processing systems;
providing a communications apparatus to one or more of said data processing systems;
the computational flow dynamics software receiving input from one or more sensors measuring air flow and temperature; and
the communication apparatus communicating with others of said plurality of data processing systems.

17. The computer program product of claim 16, wherein
said data processing system has one or more outer surfaces; and
said one or more sensors located on said one or more outer surfaces so as to provide information as to boundary conditions for the computational flow dynamics software.

18. The computer program product of claim 16, wherein said communication apparatus sends and receives data from said one or more sensors between the computational flow dynamics software located in respective data processing systems.

19. The computer program product of claim 16, wherein said computational flow dynamics software generates a configuration mesh based on each of the data processing system positioning, dimensions and boundary conditions.

20. The computer program product of claim 16, further comprising the step of sending initialization data between the computational flow dynamics software in respective data processing systems.
